(19) United States
(12) Patent Application Publication
(10) Pub. No.: US 2008/0123624 A1
(43) Pub. Date: May 29, 2008

(54) Controlling mobile voice calls remotely via a web interface

(75) Inventors: Toni Strandell, Helsinki (FI); Tuomas Tammi, Helsinki (FI)

Correspondence Address: SQUIRE, SANDERS & DEMPSEY L.L.P., 8000 TOWERS CRESCENT, 14TH FLOOR, TYSONS CORNER, VA, 22182-2700, US

(73) Assignee: NOKIA CORPORATION

(21) Appl. No.: 11/477,761

(22) Filed: Jun. 30, 2006

(51) Int. Cl. H04L 12/66

(52) U.S. Cl. 370/352; 370/401

(57) ABSTRACT

The invention allows controlling mobile voice calls remotely from a computing device. A wireless Internet connection is established from a voice call enabled mobile device to a gateway. Then, the established wireless Internet connection is monitored at the mobile device. If a voice call initiation request is received via the monitored wireless Internet connection, then the mobile device is operated to initiate a voice call to at least one recipient indicated by the received voice call initiation request.

### BACKGROUND OF THE INVENTION

1. Field of the Invention

The invention relates to telecommunications. In particular, the invention relates to a novel and improved remote control of voice calls via a web interface.

2. Description of the Related Art:

These days, mobile telephones are a common way to make voice calls. A typical mobile telephone is compact and light and therefore convenient to carry around. In many situations, a mobile telephone is also convenient enough to operate directly via its interface, such as a keypad and a display.

However, there are also situations in which it is desirable to be able to control the mobile telephone remotely, that is, via an interface other than the one physically attached to the mobile telephone device.

For example, when one is using a personal computer or a laptop computer and needs to make a call with one's mobile telephone, one has to suspend whatever one was doing with the computer and pick up the mobile telephone and dial the telephone number to be called manually with the keypad or other such input device of the mobile telephone.

In such cases, it would be highly desirable to be able to operate the mobile telephone remotely utilizing the same personal computer or laptop computer one is already using. This would typically allow making or disconnecting a call with a few mouse clicks, rather than having to suspend one's work and start handling the mobile telephone.

It is known to control a mobile telephone remotely via a wireless private data connection directly between two end-devices, such as a Bluetooth connection or an infrared connection, from a personal computer in order to install software to the mobile telephone, to delete software from the mobile telephone, to synchronize files and/or data between the mobile telephone and the computer, to edit calendar entries, and to edit phonebook entries.

Furthermore, it is known to receive event notifications from a mobile telephone to a computer which event notifications include notifications informing about missed calls and notifications informing about low battery level of the mobile telephone.

Furthermore, it is known to control a mobile telephone remotely via a wireless private data connection directly between two end-devices, such as a Bluetooth connection or an infrared connection, from a personal computer equipped with customized remote control software in order to make calls with the mobile telephone.

However, prior art fails to provide a solution in which a mobile telephone is remotely controlled via a wireless Internet connection, such as a General Packet Radio Service (GPRS) connection, a Wireless Local Area Network (WLAN) connection or a 3rd Generation Partnership Project (3GPP) connection, in order to make voice calls with the mobile telephone.

Furthermore, prior art fails to provide a solution in which a mobile telephone is remotely controlled from a computer which is not equipped with any customized remote control software, in order to make voice calls with the mobile telephone.

Since the prior art solutions require installing special remote control software in the computer, they often are of no use. For example, such solutions cannot be utilized when one is using a computer provided by a net cafe, a net kiosk, a library, or an airport. Obviously, one cannot install any software in such publicly provided computers.

Therefore, an object of the present invention is to alleviate the problems described above and to introduce a solution that allows controlling mobile voice calls remotely from a computing device without having to install any software to the computing device. Another object of the present invention is to introduce a solution that allows controlling mobile voice calls remotely from a computing device via a wireless Internet connection.

### SUMMARY OF THE INVENTION

A first aspect of the present invention is a method in which a wireless Internet connection is established from a voice call enabled mobile device to a gateway. Then, the established wireless Internet connection is monitored at the mobile device. If a voice call initiation request is received via the monitored wireless Internet connection, then the mobile device is operated to initiate a voice call to at least one recipient indicated by the received voice call initiation request. In an embodiment of the invention, the method of the first aspect is performed by a data-processing device controlled by a computer program embodied on a computer readable medium.

A second aspect of the present invention is a voice call enabled mobile device which comprises a remote controller configured to establish a wireless Internet connection from the mobile device to a gateway. The remote controller is further configured to monitor the established wireless Internet connection. The remote controller is further configured to operate, in response to a voice call initiation request received via the monitored wireless Internet connection, the mobile device to initiate a voice call to at least one recipient indicated by the received voice call initiation request.

A third aspect of the present invention is a method in which a connection identifier is assigned at a gateway. The connection identifier indicates a voice call enabled mobile device. The connection identifier is assigned in response to an establishment of a wireless Internet connection from the mobile device to the gateway. Next, a voice call initiation request addressed to the assigned connection identifier is received at the gateway. The voice call initiation request indicates at least one recipient. Then, the received voice call initiation request is forwarded from the gateway to the mobile device indicated by the assigned connection identifier. In an embodiment of the invention, the method of the third aspect is performed by a data-processing device controlled by a computer program embodied on a computer readable medium.

A fourth aspect of the present invention is an apparatus which comprises a gateway configured to assign a connection identifier indicating a voice call enabled mobile device in response to an establishment of a wireless Internet connection from the mobile device to the gateway. The gateway is further configured to receive a voice call initiation request indicating at least one recipient and addressed to the assigned connection identifier. The gateway is further configured to forward the received voice call initiation request to the mobile device indicated by the assigned connection identifier.

A fifth aspect of the present invention is a system which comprises a voice call enabled mobile device. The system of the fifth aspect further comprises a remote controller included in the mobile device and configured to establish a wireless Internet connection from the mobile device to a gateway. The remote controller is further configured to monitor the established wireless Internet connection. The remote controller is further configured to operate, in response to a voice call initiation request received via the monitored wireless Internet connection, the mobile device to initiate a voice call to at least one recipient indicated by the received voice call initiation request.

The system of the fifth aspect further comprises a gateway configured to assign a connection identifier indicating the mobile device in response to the establishment of the wireless Internet connection from the mobile device to the gateway. The gateway is further configured to receive the voice call initiation request indicating the at least one recipient and addressed to the assigned connection identifier. The gateway is further configured to forward the received voice call initiation request to the mobile device indicated by the assigned connection identifier.

The system of the fifth aspect further comprises a computing device which comprises a web browser configured to access web sites. The system of the fifth aspect further comprises a web server configured to store a list of recipients specific to the mobile device. The web server is further configured to display the list of recipients on a web site accessible by the web browser. The web server is further configured to dispatch the voice call initiation request addressed to the assigned connection identifier and indicating the at least one recipient which at least one recipient was selected from the list of recipients with the web browser.

A sixth aspect of the present invention is a method in which a wireless Internet connection is established from a voice call enabled mobile device to a gateway. Then, in response to the establishment of the wireless Internet connection from the mobile device to the gateway, a connection identifier is assigned at the gateway which connection identifier indicates the mobile device. The established wireless Internet connection is then monitored at the mobile device.

Further in accordance with the sixth aspect, a web site displaying a list of recipients specific to the mobile device is accessed with a web browser included in a computing device. At least one recipient is selected from the list of recipients with the web browser. Then, a voice call initiation request is dispatched from the web server. The voice call initiation request is addressed to the connection identifier assigned to the mobile device which the displayed list of recipients was specific to. Furthermore, the voice call initiation request indicates the at least one recipient which was selected with the web browser.

Further in accordance with the sixth aspect, the dispatched voice call initiation request is received at the gateway. Then, the received voice call initiation request is forwarded from the gateway to the mobile device indicated by the connection identifier to which the received voice call initiation request was addressed. Next, in response to the voice call initiation request received via the monitored wireless Internet connection, the mobile device is operated to initiate a voice call to the at least one recipient indicated by the received voice call initiation request.

An seventh aspect of the present invention is a voice call enabled mobile device which comprises a remote controlling means for establishing a wireless Internet connection from the mobile device to a gateway, for monitoring the established wireless Internet connection, and for operating, in response to a voice call initiation request received via the monitored wireless Internet connection, the mobile device to initiate a voice call to at least one recipient indicated by the received voice call initiation request.

In an embodiment of the invention, the mobile device is operated to control the initiated voice call in accordance with at least one control parameter included in one of the received voice call initiation request and at least one subsequently received voice call control request.

In an embodiment of the invention, controlling the initiated voice call comprises at least one of disconnecting at least one recipient from the initiated voice call, adding at least one recipient to the initiated voice call, putting the initiated voice call on hold, continuing the initiated voice call on hold, and operating a speaker included in the mobile device.

In an embodiment of the invention, the web server is further configured to update the list of recipients periodically based on received update information.

The invention allows controlling mobile voice calls remotely from a computing device without requiring any control software to be installed in the computing device. As a result, the invention allows controlling mobile voice calls remotely from a computing device even in situations where installing any software to a computing device is impossible or at least very inconvenient, e.g. when the computing device is a public computer such as a computer provided by a net cafe, a net kiosk, a library, or an airport. Furthermore, the invention allows controlling mobile voice calls remotely from a computing device via a wireless Internet connection. As a result, the invention allows controlling mobile voice calls remotely from a computing device even in situations where wireless private data connections directly between the mobile device and the computing device, such as a Bluetooth connection or an infrared connection, are unavailable.

### BRIEF DESCRIPTION OF THE DRAWINGS:

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a system according to an embodiment of the present invention, and

FIG. 2 is a diagram illustrating a method according to an embodiment of the present invention.

### DETAILED DESCRIPTION OF THE PREFERRED EMBODIMENTS:

Reference will now be made in detail to the embodiments of the invention, examples of which are illustrated in the accompanying drawings.

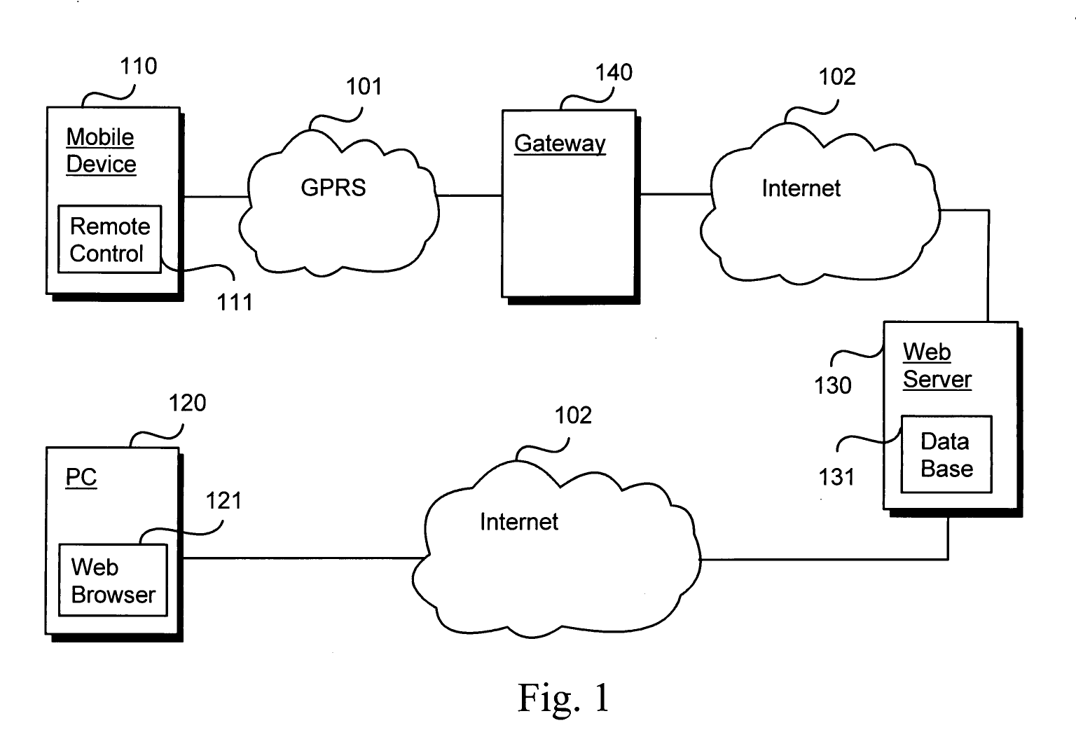

FIG. 1 illustrates a system according to an embodiment of the present invention. The system of the embodiment of the invention illustrated in FIG. 1 comprises a voice call enabled mobile device 110. In the embodiment illustrated in FIG. 1 the voice call enabled mobile device 110 is a mobile telecommunication device such as a mobile telephone. It is to be understood that the term “voice call” is used to refer to any wireless voice calls made from a mobile device. For example, a voice call may be a VOIP (Voice over Internet Protocol) call made from a mobile device, as well as a conventional cellular voice call.

The system of the embodiment of the invention illustrated in FIG. 1 further comprises a remote controller 111. The remote controller 111 is included in the mobile device 110. Furthermore, the remote controller 111 is configured to establish a wireless Internet connection from the mobile device 110 to a gateway 140. The remote controller 111 is further configured to monitor the established wireless Internet connection. The remote controller 111 is further configured to operate, in response to a voice call initiation request received via the monitored wireless Internet connection, the mobile device 110 to initiate a voice call to at least one recipient indicated by the received voice call initiation request.

Furthermore, the remote controller 111 may be configured to control the initiated voice call in accordance with at least one control parameter included in one of the received voice call initiation request and at least one subsequently received voice call control request. For example, the remote controller 111 may be configured to operate the mobile device 110 to disconnect at least one recipient from the initiated voice call, add at least one recipient to the initiated voice call, put the initiated voice call on hold, continue the initiated voice call on hold, and operate a speaker (not illustrated) included in the mobile device 110. Operating the speaker may include turning the speaker on in response to detecting no headset (not illustrated) attached to the mobile device 110, turning the speaker off, and controlling the volume of the speaker.

In an embodiment, the remote controller 111 is implemented as software. For example, the remote controller 111 may comprise a mobile web server module (not illustrated) comprising e.g. a mobile Apache (mApache) web server which is able to create wireless Internet connections and to listen out for incoming connection requests, and which therefore can be reached by the web server 130 via the gateway 140. In addition to the mobile web server module, the remote controller 111 may comprise a command module (not illustrated) able to operate the mobile device 110 to initiate and control voice calls. Alternatively, the mobile web server module may be configured to operate the mobile device 110 directly. In another embodiment, the remote controller 111 is implemented as hardware.

For example, if the remote controller 111 comprises the mobile web server module, the mobile web server module may be configured to maintain a first web page which, when called by the web server 130 with the voice call initiation request, causes a program (e.g. a program comprised in the command module) to be run on the mobile device 110 for initiating the voice call to the selected at least one recipient and e.g. optionally turning on the speaker if no headset is attached to the mobile device 110. Correspondingly, the mobile web server module may be configured to maintain a second web page which, when called by the web server 130 with the voice call control request, causes a program (which may be the same program used for initiating the voice call or it may be another program) to be run on the mobile device 110 e.g. for disconnecting the previously initiated voice call.

Alternatively, the mobile web server module may be configured to maintain a singular web page that can be called with different parameters resulting in different actions taken. For example, when called by the web server 130 with the voice call initiation request comprising a first set of parameters (voice call initiation parameters), the singular web page causes a program to be run on the mobile device 110 for initiating the voice call to the selected at least one recipient and e.g. optionally turning on the speaker if no headset is attached to the mobile device 110. Naturally, another set of parameters (e.g. speaker parameters) may also be used to define whether to turn on the speaker or not. Correspondingly, when called by the web server 130 with the voice call control request comprising a second set of parameters (e.g. voice call disconnection parameters), the singular web page causes a program to be run on the mobile device 110 for disconnecting the previously initiated voice call.

The system of the embodiment of the invention illustrated in FIG. 1 further comprises a gateway 140 configured to assign a connection identifier indicating the mobile device 110 in response to the establishment of the wireless Internet connection from the mobile device 110 to the gateway 140. The connection identifier may be e.g. a Uniform Resource Identifier (URI).

The gateway 140 is further configured to receive from the web server 130 the voice call initiation request indicating the at least one recipient and addressed to the assigned connection identifier. The gateway 140 is further configured to. forward the received voice call initiation request to a mobile device indicated by the assigned connection identifier, i.e. the mobile device 110 in the example illustrated in FIG. 1.

The gateway 140 and the mobile device 110 are connected to each other over a wireless Internet network 101 which in the example illustrated in FIG. 1 is a General Packet Radio Service (GPRS) enabled cellular network. Correspondingly, the wireless Internet connection established between the mobile device 110 and the gateway 140 is a GPRS connection in the example illustrated in FIG. 1. In another embodiment, the wireless Internet network 101 is e.g. a Wireless Local Area Network (WLAN) enabled network in which case the wireless Internet connection established between the mobile device 110 and the gateway 140 is a WLAN connection. In yet another embodiment, the wireless Internet network 101 is e.g. a 3rd Generation Partnership Project (3GPP) enabled cellular network in which case the wireless Internet connection established between the mobile device 110 and the gateway 140 is a 3GPP data connection.

The system of the embodiment of the invention illustrated in FIG. 1 further comprises a computing device 120 which comprises a web browser 121 configured to access web sites. The computing device 120 may be e.g. a conventional personal computer or a laptop computer. Correspondingly, the web browser 121 may be a conventional web browser. The present invention requires no special or customized control software in the computing device 120. Rather, a regular web browser 121 is sufficient.

The system of the embodiment of the invention illustrated in FIG. 1 further comprises a web server 130 configured to store a list of recipients specific to the mobile device. In the example of FIG. 1, the list of recipients is stored to a data base 131 arranged in connection with the web server 130. The web server 130 is further configured to display the list of recipients on a web site accessible by the web browser 121. The web server 130 is further configured to dispatch the voice call initiation request addressed to the assigned connection identifier and indicating the at least one recipient that was selected from the list of recipients with the web browser 121.

The computing device 120 and the web server 130 are connected to each other over Internet 102 in the example illustrated in FIG. 1. The web server 130 and the gateway 140 are also connected to each other over the Internet 102 in the example illustrated in FIG. 1. In another embodiment, the web server 130 and the gateway 140 are implemented in a same physical device in which case they may communicate with each other e.g. via an inter-process communication method, as is known to those skilled in the art. The web browser 121 included in the computing device 120 may communicate with the web server 130 e.g. by utilizing Hypertext Transfer Protocol (HTTP) in a manner known to a person skilled in the art.

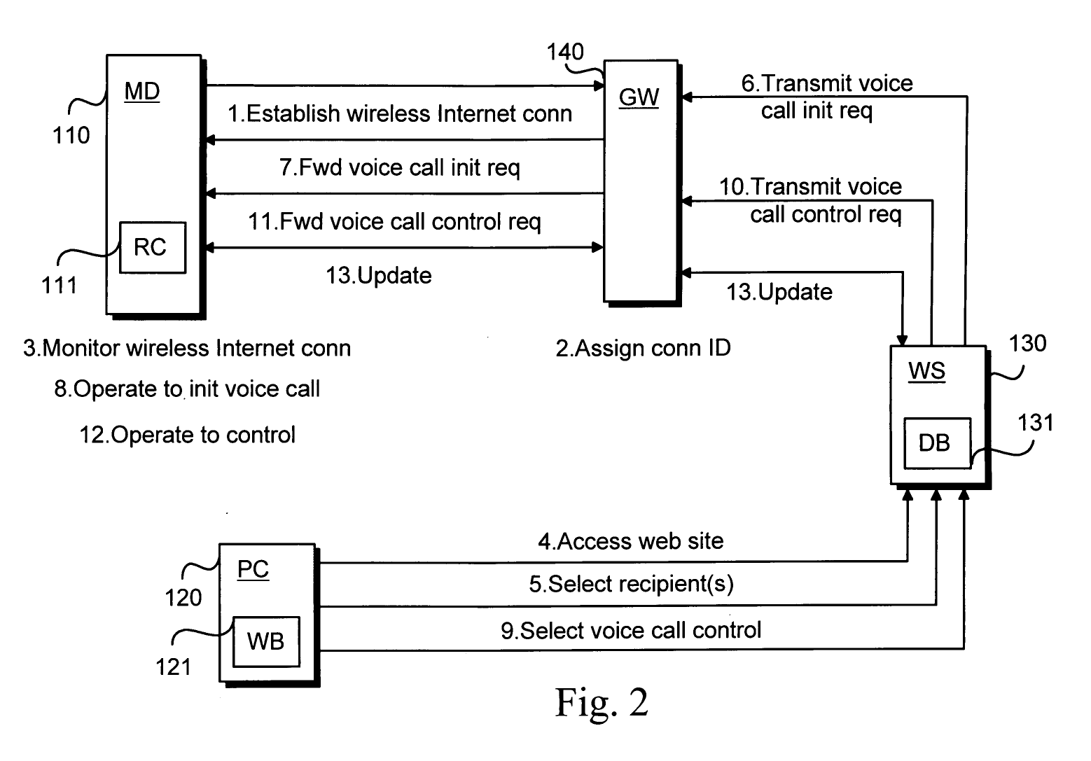

FIG. 2 illustrates a method according to an embodiment of the present invention. First, the remote controller 111 establishes a wireless Internet connection from the voice call enabled mobile device 110 to the gateway 140, step 1. Then, in response, the gateway 140 assigns a connection identifier indicating the mobile device 110, step 2. At step 3, the remote controller 111 begins to monitor the established wireless Internet connection by listening out for incoming requests. As a result, the voice call remote control service provided by the present invention is now activated.

Some time later, the user of the mobile device 110 and the computing device 120 decides to make a voice call with the mobile device 110. However, the user is engrossed with a task involving the computing device 120 and does not wish to pick up the mobile device 110 and start dialing it. Therefore, at step 4, the user accesses a web site at the web server 130 with the web browser 121 included in the computing device 120 which web site displays a list of recipients specific to the mobile device 110 of the user. In an embodiment, the user is authenticated e.g. via a logon procedure (involving e.g. a user name and password) before allowed to access the web site. The list of recipients may be stored e.g. on the data base 131 arranged in connection with the web server 130. Obviously, there may be several lists of recipients stored in the data base 131, each list specific to a mobile device of a different user. In such a case, the log-on procedure may be utilized in determining which list to display to each user on the web site.

The list of recipients specific to the mobile device 110 of the user may be obtained to the web server 130 and data base 131 e.g. from the mobile device 110 while the user utilizes the voice call remote control service provided by the present invention for the first time, that is, while the mobile device 110 of the user and the web server 130 communicate for the first time. In other words, the list of recipients may be transferred to the web server 130 from the mobile device 110. As is known, people often maintain a phonebook type of list of repeatedly used telephone numbers in their mobile telephones. Later on, the list of recipients may be updated e.g. by the web server 130 polling the mobile device 110 via the gateway 140, as indicated by step 13 in FIG. 2. Alternatively, the update/polling functionality may be implemented as a “push” type service in which the remote controller 111 periodically pushes, i.e. transmits without being first requested to do so, updated recipient information to the web server 130.

The website may display the list of recipients for example as rows where each row comprises a name of a contact and a telephone number associated with that contact. Furthermore, each row may comprise e.g. a first control button, the pressing of which selects the corresponding contact and telephone number for the voice call initiation procedure of the invention. Furthermore, each row may comprise e.g. a second control button, the pressing of which selects the corresponding contact and telephone number for the voice call disconnection procedure of the invention.

Alternatively/in addition, the website may allow the user to type in the telephone number to be called to. Alternatively/in addition, the website may provide a search interface which is connected to a telephone number provider service. The web server 130 can then receive a result page from the telephone number provider based on search terms, and format the received result page to include means (e.g. control buttons) to initiate the call.

Alternatively/in addition, the list of recipients may comprise identifiers associated with telephone numbers maintained by the user in a phonebook type of list in the mobile device 110. When a selected identifier is passed to the remote controller 111, it can then utilize the received identifier to retrieve the associated telephone number from the phonebook in the mobile device 110.

So, at step 5, the user selects at least one recipient out of the displayed list of recipients with the web browser 121. In response, a voice call initiation request is dispatched from the web server 130 and received at the gateway 140, step 6. The voice call initiation request is addressed to the connection identifier assigned earlier to the mobile device 110. Furthermore, the voice call initiation request indicates the at least one recipient which the user selected with the web browser 121.

Based on the connection identifier to which the received voice call initiation request was addressed, the gateway 140 forwards the received voice call initiation request to the mobile device 110 and the remote controller 111 included therein, step 7. Next, in response to the received voice call initiation request, the remote controller 111 operates the mobile device 110 to initiate a voice call to the at least one recipient indicated by the received voice call initiation request, step 8. The remote controller 111 may also send an acknowledgement to the web server 130 in response to having initiated the voice call, and this acknowledgement may be displayed to the user on the website. Additionally, the remote controller 111 may optionally control the initiated voice call in accordance with at least one control parameter included in the received voice call initiation request. For example, the remote controller 111 may operate the mobile device 110 to operate a speaker included in the mobile device 110, e.g. turn the speaker on in response to detecting no headset attached to the mobile device 110, and control the volume of the speaker. The website may display an additional control button, the pressing of which will instruct the remote controller 111 to perform an associated control action. These instructions may be delivered to the remote controller 111 e.g. as the above described parameters.

A while later, the user of the mobile device 110 and the computing device 120 decides to e.g. disconnect at least one recipient from the voice call initiated earlier. Again, the user does not wish to handle the mobile device 110. Therefore, the user selects disconnecting the earlier initiated voice call with the web browser 121, e.g. by pressing the above described second control button corresponding to the contact and telephone number for the earlier initiated voice call, step 9. Alternatively, the user may wish to add at least one recipient to the initiated voice call, put the initiated voice call on hold, continue the initiated voice call on hold, or operate the speaker to turn the speaker off or to control the speaker volume.

In response, a voice call control request is dispatched from the web server 130 and received at the gateway 140, step 10. The voice call control request is again addressed to the connection identifier assigned earlier to the mobile device 110. In addition, the voice call control request may again indicate the at least one recipient which the user selected with the web browser 121.

Again based on the connection identifier to which the received voice call control request was addressed, the gateway 140 is able to forward the received voice call control request to the mobile device 110 and the remote controller 111 included therein, step 11. Next, in response to the received voice call control request, the remote controller 111 operates the mobile device 110 to perform the required control action, such as to disconnect at least one recipient from the voice call, step 12.

It is obvious to a person skilled in the art that with the advancement of technology, the basic idea of the invention may be implemented in various ways. The invention and its embodiments are thus not limited to the examples described above, instead they may vary within the scope of the claims.

1. A method, comprising:
establishing a wireless Internet connection from a voice call enabled mobile device to a gateway;
monitoring the established wireless Internet connection at the mobile device for receipt of voice call initiation requests; and
operating, in response to a voice call initiation request received via the monitored wireless Internet connection, the mobile device to initiate a voice call to at least one recipient indicated by the received voice call initiation request.

2. The method according to claim 1, further comprising:
controlling the initiated voice call in accordance with at least one control parameter included in one of the received voice call initiation request and at least one subsequently received voice call control request.

3. The method according to claim 2, wherein controlling the initiated voice call comprises at least one of disconnecting at least one recipient from the initiated voice call, adding at least one recipient to the initiated voice call, putting the initiated voice call on hold, continuing the initiated voice call on hold, and operating a speaker included in the mobile device.

4. The method according to claim 1, wherein the method is performed by a data-processing device controlled by a computer program embodied on a computer readable medium.

5. A voice call enabled mobile device, comprising:
a remote controller configured to establish a wireless Internet connection from the mobile device to a gateway, to monitor the established wireless Internet connection for receipt of voice call initiation requests, and to operate, in response to a voice call initiation request received via the monitored wireless Internet connection, the mobile device to initiate a voice call to at least one recipient indicated by the received voice call initiation request.

6. A method, comprising:
assigning at a gateway a connection identifier indicating a voice call enabled mobile device in response to an establishment of a wireless Internet connection from the mobile device to the gateway;
receiving at the gateway a voice call initiation request indicating at least one recipient and addressed to the assigned connection identifier; and
forwarding the received voice call initiation request from the gateway to the mobile device indicated by the assigned connection identifier.

7. The method according to claim 6, wherein the method is performed by a data-processing device controlled by a computer program embodied on a computer readable medium.

8. An apparatus, comprising:
a gateway configured to assign a connection identifier indicating a voice call enabled mobile device in response to an establishment of a wireless Internet connection from the mobile device to the gateway, to receive a voice call initiation request indicating at least one recipient and addressed to the assigned connection identifier, and to forward the received voice call initiation request to the mobile device indicated by the assigned connection identifier.

9. A system, comprising:
a voice call enabled mobile device;
a remote controller included in the mobile device and configured to establish a wireless Internet connection from the mobile device to a gateway, to monitor the established wireless Internet connection for receipt of voice call initiation requests, and to operate, in response to a voice call initiation request received via the monitored wireless Internet connection, the mobile device to initiate a voice call to at least one recipient indicated by the received voice call initiation request;
a gateway configured to assign a connection identifier indicating the mobile device in response to the establishment of the wireless Internet connection from the mobile device to the gateway, to receive the voice call initiation request indicating the at least one recipient and addressed to the assigned connection identifier, and to forward the received voice call initiation request to the mobile device indicated by the assigned connection identifier;
a computing device comprising a web browser configured to access web sites; and
a web server configured to store a list of recipients specific to the mobile device, to display the list of recipients on a web site accessible by the web browser, and to dispatch the voice call initiation request addressed to the assigned connection identifier and indicating the given recipients selected from the list of recipients with the web browser.

10. The system according to claim 7, wherein the web server is further configured to update the list of recipients periodically based on received update information.

11. A voice call enabled mobile device, comprising:
remote controlling means for establishing a wireless Internet connection from the mobile device to a gateway;
monitoring means for monitoring the established wireless Internet connection for receipt of voice call initiation requests; and
operating means for operating, in response to a voice call initiation request received via the monitored wireless Internet connection, the mobile device to initiate a voice call to at least one recipient indicated by the received voice call initiation request.
